(19) United States
(12) Patent Application Publication
(10) Pub. No.: US 2016/0285542 A1
(43) Pub. Date: Sep. 29, 2016

(54) MOBILE PASSENGER ENTERTAINMENT AND INFORMATION SYSTEM

(71) Applicant: GLOBAL SKY TECHNOLOGIES, LLC, Bellevue, WA (US)

(72) Inventor: Qingguo Du, Bellevue, WA (US)

(21) Appl. No.: 15/053,937

(22) Filed: Feb. 25, 2016

Related U.S. Application Data
(63) Continuation of application No. 15/019,654, filed on Feb. 9, 2016.
(60) Provisional application No. 62/138,021, filed on Mar. 25, 2015.

(51) Int. Cl. H04B 7/185; H04W 4/06

(52) U.S. Cl. CPC H04B 7/18506; H04W 4/06

(57) ABSTRACT

A mobile passenger entertainment and information system that includes a control device, a plurality of passenger devices, a satellite communication device, a set of managing software, a plurality of power connectors, and a plurality of theft prevention kits. The passenger device assigned to each passenger seat includes a display screen, data storage and wireless communication capabilities. The control device manages and maintains wireless communications, via various channels, for managing entertainment activities, updates, passenger data and vehicle data collection. The managing software running on the control device and the passenger devices automates system functions and manages user activities.

### BACKGROUND PRESENT DISCLOSURE

1. Technical Field

This present disclosure relates to passenger entertainment and information systems and, more particularly, to a system and device for passenger entertainment and methods for managing system data, vehicle data, and passenger data, including controlling wireless communications between entertainment devices on a vehicle and a remote storage having data stored therein.

2. Description of the Related Art

The popularity of digital reading has increased dramatically in recent years. With today's technology, travelers can easily access electronic books, magazines, news, and entertainment from portable electronic devices. The high-resolution displays and real-time digital publications provide travelers with rich entertainment and up-to-date information. One type of In-flight entertainment (IFE) has display screens embedded into the seat-backs or seat arms for passengers. Another type of IFE is the portable media player (PMP). PMPs can be handed out and collected by a crew member.

However, the embedded IFE is very expensive with screens in awkward positions for passengers to comfortably view, and the portable IFE requires a laborious process for crew members, who must keep recycling the PMPs and updating media contents. What is needed is an IFE system that not only is affordable but also allows passengers to comfortably watch, read, and listen to digital media during their travels. What is also needed is an IFE system that is easy to manage and capable of updating media content at any time, including during travel.

Every aircraft is equipped with a flight recorder, known as a black box. The purpose of which is to facilitate the investigation of aviation incidents. Federal Aviation Administration regulations require the black box to be capable of surviving severe conditions, such as those likely to be experienced during an aircraft accident. However, current black box technology has significant drawbacks, including limited battery life (for beacon transmission), a difficult tracking capability in certain environments, and lack of durability (many have been too damaged to read). Undoubtedly, a physical flight recorder device is necessary, and continued improvements should be made to enhance this technology. Yet, a virtual black box, which is an integrated information system, is needed to transmit vehicle data to the ground as a supplemental device.

### BRIEF SUMMARY

The present disclosure is a standalone system, providing not only IFE for passenger enjoyment, but also a flight recorder available anywhere anytime in the event of flight investigation.

In accordance with one aspect of the present disclosure, a method for enabling a control device on a vehicle to control wireless communications between a plurality of passenger devices on the vehicle and a remote storage that is remote from the vehicle and having data stored therein is provided. The method includes enabling wireless communication between the control device and all the passenger devices; enabling wireless communication between the control device on the vehicle and the remote storage; enabling delivery of vehicle data and delivery of passenger data from the control device on the vehicle to the remote storage; and enabling delivery of system data from the remote storage to the control device and to the passenger devices on the vehicle.

In accordance with another aspect of the present disclosure, the method includes collecting vehicle data via the control device from the passenger devices as well as from one or more data gathering devices, such as sensors and electronic data feed and other known data gathering devices, that are communicatively coupled to the control device, the vehicle data including information about location of the vehicle, environmental conditions interior and exterior to the vehicle, vehicle performance, and logs, announcements and voice recordings from vehicle personnel. The method further includes pushing the vehicle data from the control device to the remote storage.

In accordance with another aspect of the present disclosure, the method further includes collecting passenger data via the control device that is initiated from the passenger device, the passenger data including passenger feedback and comments, product and service purchases, seat number, booking number and payment, and further comprising pushing the passenger data from the control device to the remote storage.

In accordance with still yet another aspect of the present disclosure, the method further includes initially determining if system data, which includes data for computer software and data content, is on the remote storage that is designated for selected passenger devices on the vehicle.

In accordance with yet a further aspect of the present disclosure, the method includes pushing the designated system data to the selected passenger devices on the vehicle in response to the determining if system data is on the remote storage that is designated for selected passenger devices on the vehicle.

In accordance with yet a further aspect of the present disclosure, the method includes analyzing the designated system data and taking an action to update computer software or data content to the selected passenger devices on the vehicle in response to receiving the designated system data on the selected passenger devices.

In accordance with a further aspect of the present disclosure, the method further includes manual functions for vehicle personnel to manually override the automated functions, to respond to passenger request, to broadcast announcement to the passenger device, and to push system data to the passenger device.

In accordance with another aspect of the present disclosure, a system is provided for use on a vehicle that carries one or more passengers and a crew, the vehicle including seats for the passengers, the system including one control device for the crew and a plurality of passenger devices assigned to the passenger seats for the passengers, and a data storage remote from the vehicle that stores system data to be delivered to the control device and the passenger devices and stores passenger data and vehicle data collected by the control device from the vehicle.

In accordance with another aspect of the present disclosure, a system for use with a remote storage is provided, the system including a vehicle that carries one or more passengers and a crew, the vehicle including seats for the one or more passengers, a control device for the crew and a plurality of passenger devices assigned to the passenger seats for the passengers. The control device on the vehicle receives vehicle data and passenger data from the plurality of passenger devices as well as one or more data gathering devices that are communicatively coupled to the control device, and the control device pushes the vehicle data and the passenger data from the control device to the remote storage and pushes system data from the remote storage to the control device and the plurality of passenger devices.

As will be readily appreciated from the foregoing, the system and method of the present disclosure provides a complete and mobile entertainment and information system with novel as well as familiar functions for a mere fraction of the cost of conventional products. Passengers can comfortably enjoy the latest entertainment and system functions while vehicle data and passenger data are systematically collected and transmitted to the ground.

### BRIEF DESCRIPTION OF THE DRAWINGS

The foregoing and other features and advantages of the present disclosure will be more readily appreciated as the same become better understood from the following detailed description when taken in conjunction with the following drawings, wherein:

FIG. 1 is a perspective view of an aircraft cabin illustrating a mobile passenger entertainment and information system (MPEIS) formed in accordance with the present disclosure;

FIG. 2 is an exemplary drawing of different placements of the MPEIS hardware in an aircraft in accordance with the present disclosure;

FIG. 3 is an exemplary top-level diagram illustrating data communications for retrieving system data from, and uploading vehicle data and passenger data to, a remote storage on the ground;

FIG. 4 is a more detailed drawing of system data retrieved and distributed by a control device to selected passenger devices.

FIG. 5 is a more detailed drawing of vehicle data collected and uploaded by a control device to a remote storage.

FIG. 6 is a more detailed drawing of passenger data collected and uploaded by a control device to a remote storage.

FIG. 7 is a diagram illustrating both hardware and software components of a control device and a plurality of passenger devices and a snapshot of peer-to-peer communication sessions of the MPEIS in accordance with the present disclosure; and

FIG. 8 is a flow chart of a method implemented in software for automating system functions and communications of the MPEIS.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with passenger vehicles, such as aircraft, ships, trains, buses, automobiles, as well as remote storage facilities that store data content for wireless retrieval, and the like have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases in “one implementation” or “in an implementation” in various places throughout the specification are not necessarily all referring to the same implementation. Furthermore, the particular features, structures, or characteristics may be combined in any suitable manner in one or more implementations.

This present disclosure, hereafter referred to as the Mobile Passenger Entertainment and Information System (MPEIS), is for passenger vehicles, such as trains, automobiles, and, more particularly, for aircraft. It should be understood that the system may be used in other passenger vehicles, particularly vehicles containing individual seats.

The MPEIS is a standalone and mobile system, able to function independently on the aircraft. The MPEIS comprises entertainment devices, which include one control device and a plurality of passenger devices assigned to passenger seats, a satellite communication device, a set of managing software, a plurality of power connectors, and a plurality of theft prevention kits.

The control device, managed by cabin crew, can communicate with, not only all the passenger devices via a wireless local area network, but also the internet via the satellite communication device, a cellular network or a Wi-Fi network. The satellite communication device is enabled for internet connectivity and GPS tracking during flight when the cellular network or the Wi-Fi network is not available. The control device manages and maintains communications with all the passenger devices and data collecting devices on the aircraft and with a remote storage on the ground.

The remote storage on the ground is preferably an internet-based remote storage on the ground. It is configured or structured to maintain system data, such as media content, product and service catalog, software, travel data and other information, and that can be intended for selected entertainment devices, e.g., passenger devices. The system data is retrieved by the control device via the internet, and it is securely distributed to selected passenger devices on the aircraft.

Vehicle data, such as aircraft location, speed, interior and exterior environmental conditions, vehicle performance, and logs, announcements and voice conversations from the crew, are collected via the control device from the passenger devices and one or more data gathering devices, such as without limitation sensors and electronic data feed as well as other known data gathering devices, that are communicatively coupled to the control device, and that are stored to a data location on the remote storage by the control device when the aircraft is in flight.

Passenger data includes without limitation such data as passenger comments and feedback, product and service purchases, seat number, booking number and payments, is originated from the passenger device and is collected by the control device. It is selectively or automatically stored by the control device to a data location on the remote storage.

Each passenger device is connected to a single power connector, which supplies low voltage power from the passenger seat power supply.

A theft prevention kit includes hardware and software that is used for securing the passenger device from being taken without authorization from the passenger seat.

The control device and the passenger device are preferably built on tablet computers specifically configured with a high resolution display, a data storage and wireless communication capabilities. A unique set of managing software, which includes a piece of peer-to-peer (P2P) middleware and a piece of system management software, is developed and configured for this system. As such the control device and the passenger device are novel adaptations of conventional computing devices that include heretofore unknown combinations of features and functionality as described in more detail herein. The P2P middleware provides efficient large media data distribution based on a P2P protocol, while the system management software automates and manages system functions and user interactions.

The P2P protocol is a well-known protocol that is readily commercially available and will not be described in detail herein. Briefly, it is a decentralized communication model in which each party has the same capabilities, and either party can initiate a communication session. Unlike the client/server model, in which the client makes a service request and the server fulfills the request, the P2P network model allows each node to function as both a client and server.

The system management software enables, secures and optimizes communications between the passenger devices and the control device and the remote storage. Preferably, in this system the passenger devices are not configured to communicate directly with one another. Rather, all communications with the passenger devices goes to and from the control device. The system management software automates system data delivery to selected passenger devices on the aircraft as well as vehicle data and passenger data collection and transmission to the remote storage on the ground.

With the managing software deployed to the entertainment devices (control device and the passenger devices), the crew can communicate with all or selective passengers via text, voice or video via the control device; while the passenger can communicate with the crew or other passengers from his or her passenger device via the control device.

Some of the key technologies and features in this system and its components are self-contained design, automated system management, efficient large data delivery and system update, and secured vehicle data and passenger data collection and transmission.

The MPEIS provides a complete and mobile IFE and information system with the familiar functions for a mere fraction of the cost of conventional products. With the elimination of media servers and miles of audio and video wires on the aircraft, the system of the present disclosure dramatically simplifies system deployment and operations for airlines, significantly reduces weight and energy consumption for aircrafts, and instantly helps with accident recovery and investigation.

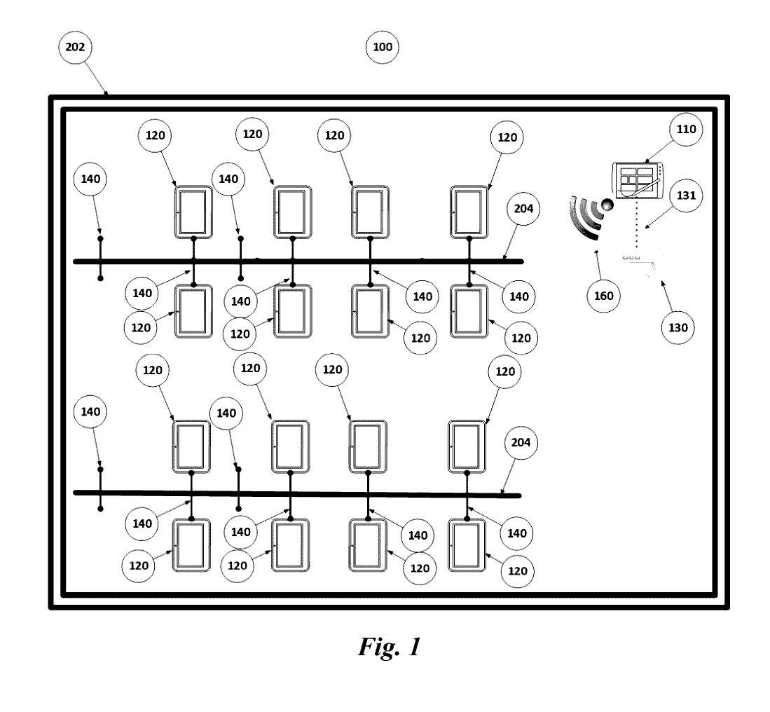

Referring initially to FIG. 1, shown therein is an overview of a Mobile Passenger Entertainment and Information System (MPEIS) 100 in connection with a vehicle. In the representative implementation illustrated and described herein, the vehicle is a commercial passenger aircraft 202. It is to be understood that the vehicle may be any type of conveyance designed to carry passengers, including without limitation, aircraft, space craft, sub-space vehicles, ships, boats, ferries, trains, monorails, and buses, to name a few. The present disclosure may be implemented in any size of vehicle, and it applies to vehicles that carry one or more passengers, either exclusively or in combination with cargo.

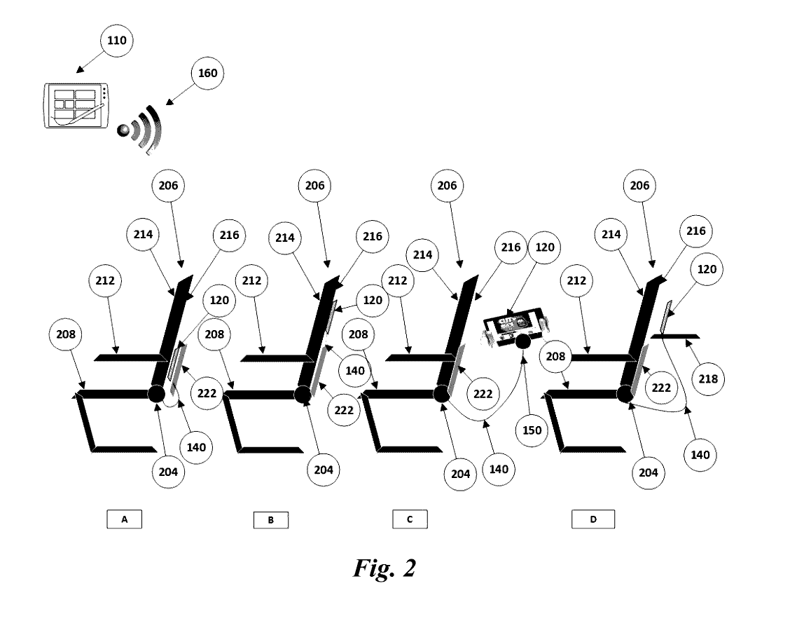

The aircraft 202 is equipped with one or more seats 206 that are designed to hold a single passenger, as shown more particularly in FIG. 2. Each seat 206 includes a seat top 208, backrest 214, armrests 212 (foldable or permanent), and a seat back 216. Associated with each seat is a tray table 218, which may be stowed and deployed from the seat back 216 that is immediately in front of the passenger seat 206 or from an armrest 212 associated with the passenger seat as is commonly used in the airline industry. Because such seats 206 are well-known and readily commercially available, they will not be described in detail herein. It is to be understood that the present disclosure may be implemented with seats that are configured to hold two or more passengers, or even a bench style seat, with or without a backrest and arms.

The illustrations in FIGS. 1 and 2 are not a scale representation of an aircraft passenger cabin, and they are intended as a representation of one seating configuration. The system 100 can be implemented in any seating configuration.

The system 100 also includes a passenger device 120, which is shown schematically in FIG. 1 and more pictorially in FIG. 2. Ideally the passenger device 120 is attached or tethered to a passenger seat 206 or seat tray 218, or in the seat back 216. The passenger device 120 is powered by a cabin in-seat power supply 204 via a power connector 140. The number of passenger devices 120 per aircraft seating configuration can be adjusted. For example, FIG. 1 shows several power connectors 140 without an associated passenger device 120.

As depicted in FIG. 1, the system 100 further includes a control device 110 that communicates with all the passenger devices 120 via a wireless local area network 160, which can be enabled and provided by the control device 110 when an existing local area network cannot be found or used. The control device 110 and the passenger device 120 are preferably built on tablet computers, which utilize commercially available hardware, including display screens, data storage and wireless communication modems, and managing software, including P2P middleware and system management software as described more fully below. The hardware is configured to perform functions unique to this implementation as described more fully below. The control device is a unique device that has a unique function in the disclosed system. Its construction and function will be described in more detail below in conjunction with other system components.

Still referring to FIG. 1, the system further includes a satellite communication device 130 connected to the control device 110 via a wire (such as a USB wired connector) or wireless technology (such as Bluetooth) 131, and it provides internet connectivity and GPS location data for the control device 110 during flight. The control device 110 is also equipped with cellular and Wi-Fi modems, which can establish internet connectivity more likely when the aircraft 202 is on the ground. Because the satellite communication device 130 is well-known and commercially available, it will not be described in greater detail. The control device 110 and the satellite communication device 130 are mobile devices, and they are managed by the vehicle personnel.

In FIG. 2, there are shown different placements of the passenger device 120. The passenger device 120 can be stowed in the back pocket 222 of a seat 206 as labeled in position A, hung on a seatback 216 as labeled in position B, held in passenger hands as labeled in position C, or placed on a tray table 218 as labeled in position D.

As shown in position C of FIG. 2, the passenger device 120 is powered by the in-seat power supply 204 via the power connector 140, and secured by a theft prevention kit 150.

In further detail, still referring to FIG. 2, the control device 110 is a mobile device to be managed and operated by the crew. The control device 110 is equipped with a wireless local area network 160, which can be enabled and disabled by the managing software installed on the control device as and when needed. The wireless local area network 160 operates under “infrastructure” mode of IEEE 802.11 standard and provides wireless communication channels between the control device 110 and the passenger devices 120. The control device 110 can set, configure, and control system wireless communications between entertainment devices. The location of the control device 110 in the aircraft 202 is determined in part by wireless communication needs, such as signal range and strength, as well as by access to power and to other devices communicatively coupled to the control device 110.

Still referring to FIG. 2, the passengers can not only comfortably watch, read and listen to digital media with the passenger devices 120 in various positions from the passenger seats 206, but they can also use the passenger devices 120 for communications, providing feedback, send a service request, and purchase services and products during their travels.

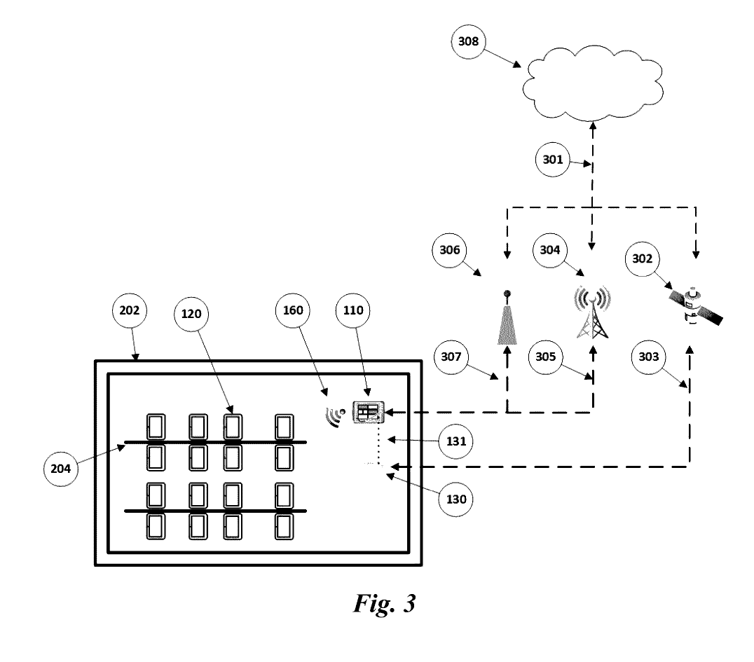

The communication architecture of the present disclosure, as shown in FIG. 3, displays data flows between the control device 110 in the aircraft cabin 202 and a remote storage 308 on the ground. In the illustrated implementation, the control device 110 manages system data retrieval, vehicle data collection and passenger data collection, all of which is stored in the internet-based remote storage 308.

Still referring to FIG. 3, Internet connectivity 301 between the control device 110 in the cabin 202 and the remote storage 308 on the ground can be established by either Wi-Fi signal 307 via a Wi-Fi access point 306 or cellular signal 305 via a cellular tower 304, or satellite signal 303 via a satellite 302 from a satellite communication device 130. The control device 110 connects with the satellite communication device 130 via a USB wire or Bluetooth 131. Data communication within the cabin 202 between the control device 110 and the passenger device 120 powered by in-seat power supply 204 is established via the wireless local area network 160.

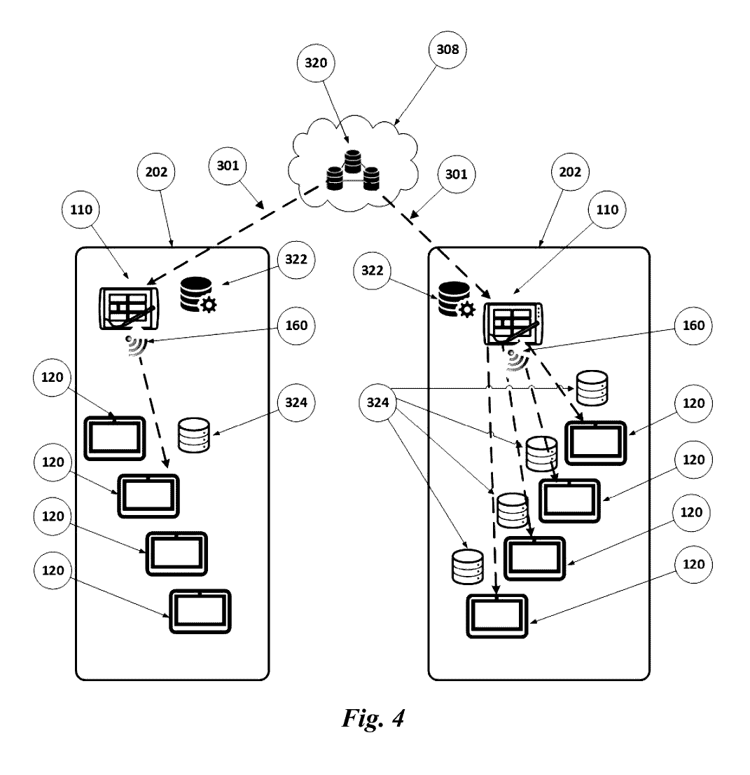

In FIG. 4, the control device 110 communicates with the ground-based remote storage 308 via the internet connection 301, and it determines if system data stored in a predetermined data location 320 is designated for the control device 110 or one or more selected passenger devices 120 in the aircraft cabin 202.

Still referring to FIG. 4, the control device 110 retrieves the designated system data with a distribution instruction 322 from the content location 320 on the remote storage 308, and it distributes the system data 324 to the selected entertainment devices for content or software update via the wireless local area network 160 in the aircraft cabin 202.

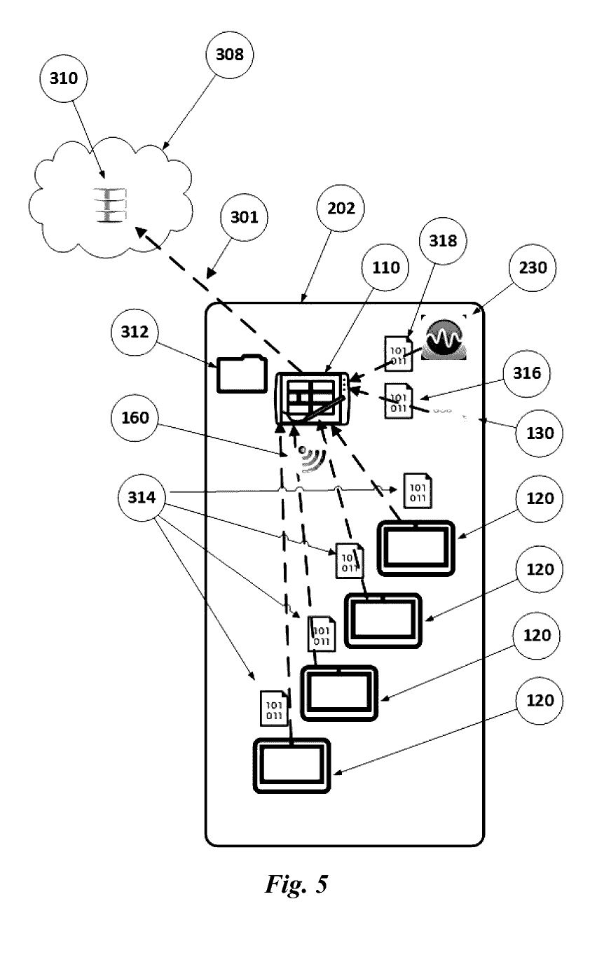

In FIG. 5, the control device 110 is illustrated collecting data about the aircraft, such as location data 316 from the GPS enabled satellite communication device 130, performance data 318 from a communicatively coupled data feed device 230, and the cabin data 314, such as cabin logs, crew announcements and crew voice conversations from the control device 110 and environmental conditions (temperature, humidity, etc.) from all passenger devices, via the wireless local area network 160. This data is collectively referred to as vehicle data 312, and it is pushed by the control device 110 to a predetermined data location 310 in the remote storage 308 via an internet connection 301.

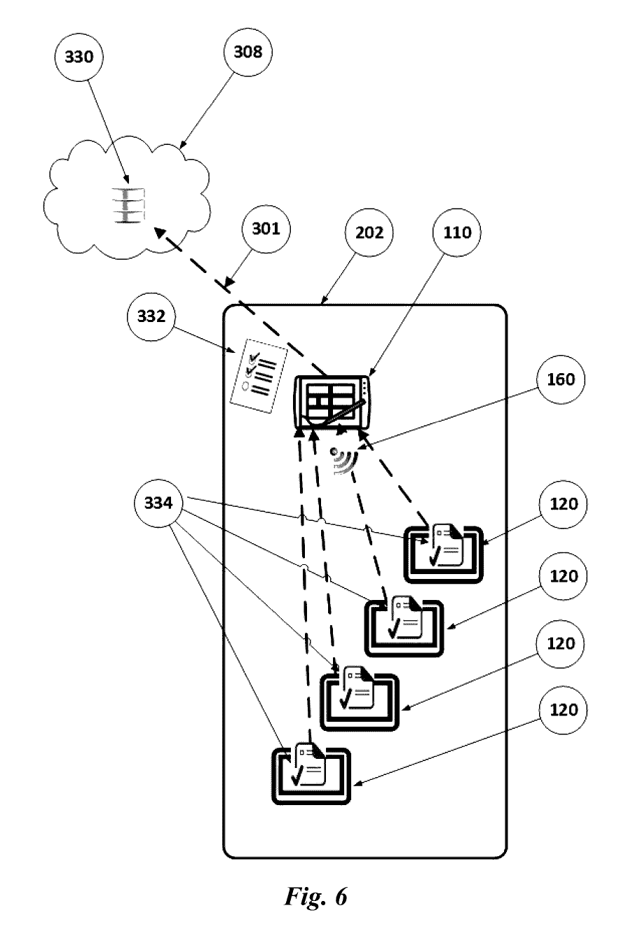

Illustrated in FIG. 6, are additional functions of the passenger device 120. In addition to play, read, watch and listen to digital media on the passenger device 120, the passenger can initiate communication and service request, provide feedback and purchase products with a user interface 334 on the passenger device 120. The passenger action 334 initiated from the passenger device 120 is sent to the control device 110 immediately via the wireless local area network 160. After processing the passenger action 334, the control device 110 determines to either alert the crew on the control device or assemble a set of passenger data 332 on the control device, or both. The control device 110 pushes the passenger data 332 to a predetermined data location 330 in the remote storage 308 via the internet connection 301.

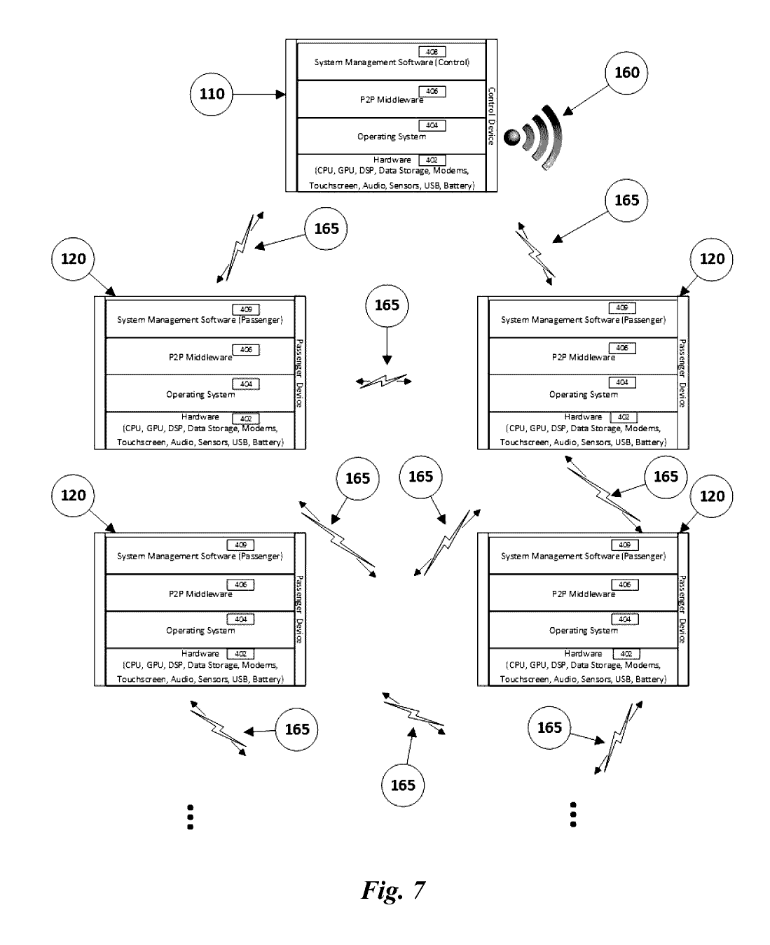

FIG. 7 illustrates hardware and software components of the devices of the system 100, including the control device 110 and the passenger device 120. A snapshot of P2P wireless communication sessions 165 among all devices is also presented. Each device 110, 120, either acting as the control or passenger device, is equipped with a list of specific hardware 402, which includes without limitation: a Central Computing Processor (CPU) that executes computer programs, a Graphical Processing Unit (GPU) that provides visual graphics processing and acceleration of images creation, a Digital Signal Processor (DSP) that speeds up arithmetic processing of real-time signals from sensors and radios, a set of data storage including both volatile and non-volatile semiconductors, a set of wireless modems supporting wireless connectivity of cellular, Wi-Fi, Bluetooth and NFC, a touchscreen for graphic display and data input, an audio processor and accessories of microphone and ear-phones, a set of sensors that provide measurement of motions, environmental parameters and physical positions, a USB port for power input, and a battery that can be recharged.

As depicted in FIG. 7, each entertainment device 110 or 120 is loaded with a list of specific software, which includes an Operating System 404 for managing hardware and services, a set of managing software including the P2P middleware 406 for efficient data distribution and the system management software, configured for either the control device 408 or the passenger device 409.

The software enables system automation, management, and user interactions.

Still referring to FIG. 7, when a new set of system data is acquired by the control device 110 from the remote storage 308, the system management software 408 and 409 integrated with the P2P middleware 406 automates and directs P2P data updates, as shown by the signal arrows 165 in a P2P session. All P2P sessions are established and routed by the wireless local area network 160. With the set of managing software, the control device 110 is able to effectively manage large data and software updates, and closely monitor the distribution and update processes to the passenger device 120.

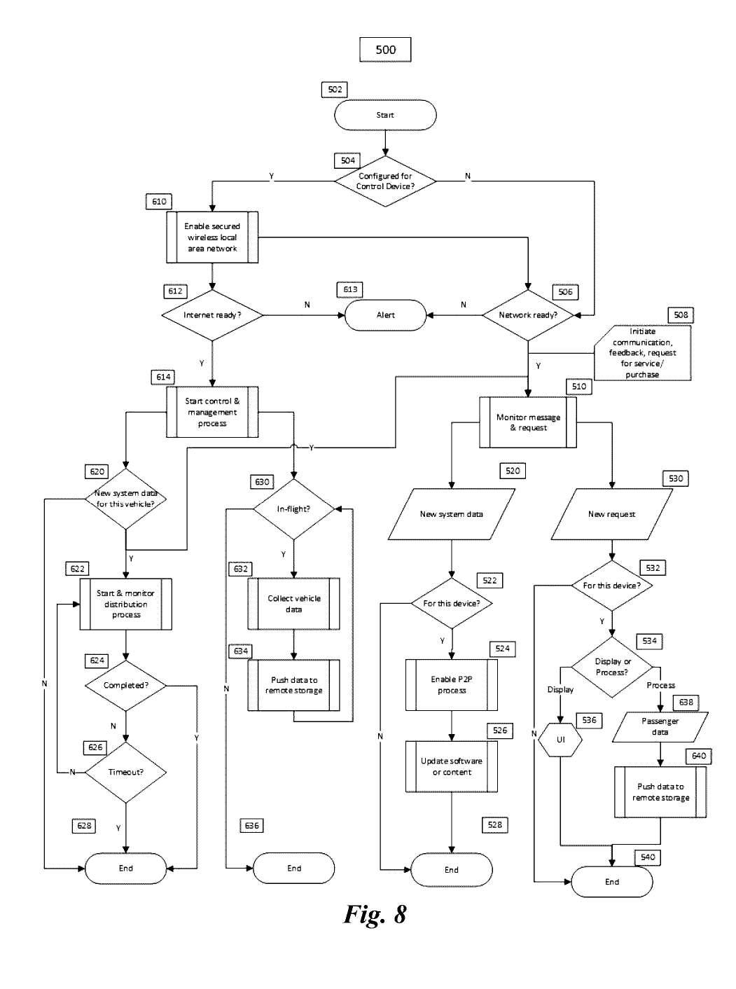

FIG. 8 displays a flow chart 500 that illustrates the managing software, which includes the system management software and the P2P middleware. The managing software is configured and loaded to all entertainment devices (control device and passenger devices) for performing specific system functions and data communications. The managing software starts in 502, and initially identifies the entertainment device that the managing software is running on to act as either a control device or a passenger device in 504. When serving as the control device, the managing software enables a wireless local area network in 610 for system communication between the entertainment devices as and when needed. The managing software on the control device checks for system operational readiness, such as wireless network 506 and internet connectivity 612, and alerts the crew for error in 613, as shown on the top section of the diagram. The control device performs system control functions with chart numbers above 600, as shown mostly on the left section, such as system management, system data update, and vehicle data and passenger data collection and upload. The lower right section of the diagram, with chart numbers between 506 and 540, represents common functions performed by all entertainment devices (control device and passenger devices) on the vehicle.

Referring to FIG. 8, illustrated therein are functions performed by the control device. On the left section of the flow chart the control device starts a computer process in 614 for managing network communications, and data detection, collection and transportation, after previously establishing the wireless local area network in 610 and verifying internet connection in 612. The control device detects and determines in 620 if there is new system data on the remote storage. When the new system data is detected, the managing software on the control device notifies one or more selected entertainment devices with a message to 510, automates and monitors a data distribution process to the selected entertainment devices (control device or passenger devices) in 622 until either confirmation is received in 624 from the selected entertainment devices (control device or passenger devices) or a timeout is triggered in 626 before completing the data distribution process in 628.

Still referring to FIG. 8, the lower second left section of the flow chart, the control device detects in 630 if the vehicle is in-flight, and starts a sub-process for collecting vehicle data in 632 when it is, then securely pushes the collected vehicle data to the remote storage on the ground in 634. When the control device detects the vehicle is no longer in flight in 630, the managing software completes the sub-process in 636.

Still referring to FIG. 8, in the right section after the wireless network 506 is detected, the managing software starts a computer process 510 that monitors network message and request, which can be initiated by the control device or the passenger device for communicating with other entertainment devices (control devices or passenger devices) or by the passenger device for passenger feedback, and service and purchase requests as shown in 508. The computer monitoring process 510 also detects the new system data notification message sent by the control device in 620.

Referring to FIG. 8 after the process 510, if the message received is for distributing the new system data in 520, the managing software on the entertainment device determines in 522 if the device is the one selected for receiving the system data, and then enables a sub-process in 524 for efficient P2P data distribution. Once the P2P process 524 receives the new system data, the managing software on the device takes an action 526 to update either software or content before finishing the sub-process in 528.

Still referring to FIG. 8 after the process 510, if the managing software detects the request is initiated for feedback, communication, service or product purchase from 508, the control device or the passenger device receives the new request 530 and identifies if the request is intended for this device in 532. If the request 530 is targeting this device, the managing software decides in 534 to either display or process. If the request 530 is intended for communicating with one or more selected passenger devices, the communication message is displayed on the selected passenger devices. If the request is for providing feedback or purchasing a service or a product, the control device is targeted for processing the request and assembling a set of passenger data in 638. The passenger data is then pushed to the remote storage in 640 by the control device before completion of handling the new request in 540.

The operation of the system will now be described in conjunction with FIGS. 1-8. A Mobile Passenger Entertainment and Information System (MPEIS) can be configured for an aircraft. The MPEIS comprises entertainment devices which include one control device for a crew member and a plurality of passenger devices assigned to passenger seats for passengers, a satellite communication device, a set of managing software, a plurality of power connectors, and a plurality of theft prevention kits. The control device and the satellite communication device are mobile devices, to be managed by the crew on the aircraft. The passenger device is attached to the passenger seat with the power connector and the theft prevention kit.

An internet-based remote storage is configured on the ground for staging: 1) system data for the entertainment devices (control device and passenger devices) on the aircraft for software and content update, 2) vehicle data collected from the aircraft for real-time flight and cabin data record, and 3) passenger data collected from the aircraft for passenger records of feedback and product and service purchases.

The crew, who manages the MPEIS on the aircraft with the control device, starts with a user interface for system management and configuration changes, such as password reset, seating arrangement, additional channels of internet connectivity, frequency of system data updates, color code for device status, and automation selections, etc. Ideally the user interface on the control device is a touch sensitive screen, eliminating the need for a mouse or other pointing device.

Under normal operation, the control device presents the crew with a user interface displaying a seating chart for all passenger devices assigned to their passenger seats and color coded status for each passenger device.

The control device automatically detects and enables a secured wireless local area network for communicating with all passenger devices when an existing local area network cannot be found or used. The control device also detects and enables an internet connection to the remote storage on the ground via either cellular, Wi-Fi, or satellite communication. The crew can overwrite the automated functions, and control these functions manually via the system management user interface on the control device.

By default, the control device automatically retrieves system data, such as media content, product and service catalog, software, travel data and other information, designated for one or more selected passenger devices, and instantaneously distributes the system data to the selected passenger devices for content or software update. When the control device is under manual control, the crew can select specific system data from a portable data storage, such as a non-volatile memory card, to update selected passenger devices from the user interface on the control device.

When the aircraft is in motion, the control device automatically detects it, and initiates a computer process for collecting vehicle data and storing it to the remote storage in real time. The control device also displays passenger request initiated from the passenger device, processes the passenger request, product and service purchases, feedback, etc. to a set of passenger data and stores the passenger data to the remote storage for record keeping.

As part of the system functionality, the crew can use the control device to broadcast either a set of pre-determined safety instructions and cabin announcements, or customized video, voice or text messages to all or selected passenger devices.

The passenger can also use his or her passenger device to communicate with the control device and other passenger devices via the control device. The passenger communication function can be enabled or disabled by the crew via the control device.

The crew can monitor the progress of the automated process, such as system data retrieval and distribution, and vehicle data and passenger data collection and transmission. The managing software on the control device provides the crew with options to delay or terminate these processes at any time.

The passengers can comfortably read, watch, play or shop with their passenger devices, which are automatically and constantly updated with latest data content and computer software, while the vehicle data and the passenger data are systematically collected and transmitted to the ground.

The present disclosure provides a mobile entertainment system for passengers, and real-time vehicle data collection and passenger data collection from the aircraft. The cost-effective design, efficient data distribution and collection, and automated system management, provide an effective product and solution to the industry.

While the present disclosure has been described referring to exemplary implementations, it will be understood by those skilled in the art that various modifications may be made and equivalents may be substituted for elements without departing from the scope of the present disclosure. Therefore, it is intended the present disclosure is not to be limited to the forms or methods disclosed, but that the present disclosure covers all modifications, equivalents, and alternatives.

1. A method for enabling a control device on a vehicle to control wireless communications between a plurality of passenger devices on the vehicle and a remote storage that is remote from the vehicle and having data stored therein, the method, comprising:
enabling wireless communication between the control device and all the passenger devices on the vehicle;
enabling wireless communication between the control device on the vehicle and the remote storage;
enabling delivery of vehicle data from the control device on the vehicle to the remote storage;
enabling delivery of passenger data from the control device on the vehicle to the remote storage; and
enabling delivery of system data from the remote storage to the control device on the vehicle and from the control device to the passenger devices.

2. The method of claim 1 further comprising collecting vehicle data via the control device from the passenger devices and from one or more data gathering devices that are communicatively coupled to the control device, the vehicle data including information about location of the vehicle, environmental conditions interior and exterior to the vehicle, vehicle performance, and logs, announcements and voice recordings from vehicle personnel, and further comprising pushing the vehicle data from the control device to the remote storage.

3. The method of claim 1 further comprising transmitting passenger data from the passenger device and collecting the passenger data via the control device initiated from the passenger device, the passenger data including passenger feedback, product and service purchases, seat number, booking number and payment, and further comprising pushing the passenger data from the control device to the remote storage.

4. The method of claim 1, further comprising initially determining if system data, which includes data for computer software and data content, is on the remote storage that is designated for one or more selected passenger devices on the vehicle.

5. The method of claim 4, further comprising pushing designated system data to the selected passenger devices on the vehicle in response to the determining if system data is on the remote storage that is designated for one or more selected passenger devices on the vehicle.

6. The method of claim 5, further comprising analyzing the designated system data and updating computer software or data content on the selected passenger devices in response to the pushing of designated system data to the selected passenger devices on the vehicle.

7. The method of claim 1 further comprising enabling the control device to allow for manual control by vehicle personnel to manually override the automated functions, to respond to passenger request, to broadcast an announcement to the passenger devices, and to push system data to the passenger devices.

8. A system for use on a vehicle that carries one or more passengers and a crew, the vehicle including seats for the passengers, the system comprising:
a control device for the crew;
a plurality of passenger devices assigned to the passenger seats for the passengers; and
a data storage remote from the vehicle that stores vehicle data and passenger data that are both collected by the control device from the vehicle and system data for delivery and update to the passenger devices on the vehicle.

9. The system of claim 8, further comprising one or more data gathering devices that are communicatively coupled to the control device on the vehicle and that collect the vehicle data, the vehicle data including information about location of the vehicle, environmental conditions interior and exterior to the vehicle, vehicle performance, and logs, announcements and voice recordings from vehicle personnel, and wherein the control device is structured to push the vehicle data to the remote storage.

10. The system of claim 8 wherein the control device that communicates with the passenger device collects the passenger data, the passenger data including passenger feedback, product and service purchases, seat number, booking number and payment, and pushes the passenger data to the remote storage.

11. The system of claim 8 wherein the control device that communicates with the passenger device and remote storage initially determines if system data, which includes data for computer software and data content, is on the remote storage that is designated for selected passenger devices on the vehicle.

12. The system of claim 11 wherein the control device is structured to push the designated system data to the selected passenger devices on the vehicle via the control device in response to the control device determining if system data is on the remote storage that is designated for one or more selected passenger devices on the vehicle.

13. The system of claim 12 wherein the selected passenger devices on the vehicle are structured to take an action to update computer software or data content on the selected passenger devices in response to receiving the designated system data pushed by the control device on the vehicle.

14. The system of claim 8 wherein the control device is structured to allow for manual control of the control device by vehicle personnel to manually override automated functions of the control device, to respond to passenger requests, to broadcast announcement to the passenger devices, and to push system data to the passenger devices.

15. A system for use with a remote storage, the system comprising:
a vehicle that carries one or more passengers and a crew, the vehicle including seats for the one or more passengers; and
a control device for the crew to communicate with the one or more passengers; and
a plurality of passenger devices assigned to the passenger seats for the passengers and structured for communication with the control device.

16. The system of claim 15 wherein the control device on the vehicle is structured to receive vehicle data and passenger data and to communicate with the remote storage to push the vehicle data and the passenger data from the control device to the remote storage.

17. The system of claim 16 wherein the control device is structured to communicate with a plurality of data gathering devices that are communicatively coupled to the control device and that collect the vehicle data, the vehicle data including information about location of the vehicle, environmental conditions interior and exterior to the vehicle, vehicle performance, and logs, announcements and voice recordings from the crew.

18. The system of claim 16 wherein the control device is structured to receive messages, feedback, service requests, and purchase requests initiated from the passenger device, and to assemble the passenger data for record keeping.

19. The system of claim 15 wherein the control device on the vehicle is structured to initially determine if system data, which includes data for computer software and data content, is on the remote storage that is designated for selected passenger devices.

20. The system of claim 19 wherein the control device is structured to push the designated system data to the selected passenger devices in response to the determining if system data is on the remote storage that is designated for selected passenger devices on the vehicle.

21. The system of claim 20 wherein the selected passenger devices are structured to take an action to update computer software or data content on the selected passenger devices in response to receiving the designated system data pushed to the selected passenger devices by the control device on the vehicle.

22. The system of claim 15 wherein the control device is structured to allow for manual control of the control device by the vehicle crew to manually override automated functions of the control device, to respond to passenger requests, to broadcast announcement to the passenger devices, and to push system data to the passenger devices.
